(19) United States
(12) Patent Application Publication
(10) Pub. No.: US 2017/0350368 A1
(43) Pub. Date: Dec. 7, 2017

(54) WIND POWER GENERATOR EMPLOYING SAILS

(71) Applicant: Adam Bednarczyk, Warszawa (PL)

(72) Inventor: Adam Bednarczyk, Warszawa (PL)

(21) Appl. No.: 15/596,947

(22) Filed: May 16, 2017

(30) Foreign Application Priority Data
May 20, 2016 (PL) P.417271

(51) Int. Cl. F03D 7/02; F03D 9/25; F03D 3/06; F03D 9/32; F03D 15/00

(52) U.S. Cl. CPC F03D 7/0204; F03D 9/32; F03D 15/00; F03D 3/061; F03D 9/25; F05B 2240/941; F05B 2240/311; F05B 2260/4021; F05B 2260/4031; F05B 2260/504; F05B 2260/505; F05B 2240/931

(57) ABSTRACT

A device and method of acquiring mechanical energy by using a wind power generator employing sails is described. A sail is mounted on a towing carriage that is used for the rotation of a propulsion wheel of the mechanical gear is added. The towing carriage is connected to a strand and the strand transfers the force originated by the sail to the propulsion wheel of the power plant. The sail has the ability of adjustment of its angle position to the direction of the wind, the total exploitation cycle of the wind power generator employing sails consists of the working part during which the sail is moving along the direction of wind.

### BACKGROUND OF THE INVENTION

### Field of the Invention

The object of the invention is a wind power generator employing sails using the energy of the wind to directly propel machines and devices or to generate electrical energy.

### Background

At present windmills are used as power plants using wind energy. In the case of windmills air particles are hitting the propeller on the windward side and transfer to propeller only a part of their momentum. The amount of transferred momentum depends on the angle between the direction of the wind and the hypothetic surface tangent to the propeller at the place of collision.

The rotating windmill propeller hits air particles from the other—leeward side and transfers part of its momentum to the particles which are hit there. This process contributes to losses of energy and the further from the axis of the propeller, the bigger the losses. A similar situation exists in the case of a wind power station with vertical axis. A rotating wing of the wind power station forces the movement of air particles from the leeward side and the speed transmitted to air particles is proportional to the distance between the place of collision and the axis of rotation. At all present wind power stations' wind propellers in windmills or other propellers are attached to their points of suspension. The suspension lowers the amount of wind energy transferred to the wind power station.

I have not found any solutions similar to the one I'm offering for a wind power generator employing sails in the literature I have read.

The aim of the solution in this invention was to find a method and device of wind power station providing higher efficiency in using kinetic energy of the wind, providing safety for birds flying nearby and eliminating infrasounds created by wind power stations which are harmful to health and also to increase maximum power gained from each square meter of the wind stream that is taken by the power station.

### SUMMARY OF THE INVENTION

Higher energy efficiency of the wind power generator employing sails will be achieved by making the air particles hit the sail at angles not much different from the right angle and guaranteeing the possibility of adjusting the position of the sail to the direction of the flow of the air. The placing of the surface of the sail perpendicularly to the direction of the wind is made possible by the utilization of the rotational base to which the sail is mounted. Better visibility of the wind power generator employing sails and small speed of movable subassemblies of the wind power station employing sails as compared with speed of movable subassemblies of windmills guarantee higher safety for birds flying near the wind power station employing sails. The expected frequency of generated ultrasounds will be considerably below one hertz, so it will be beyond the range of infrasounds harmful to the human health.

At least a twofold reduction in the cost of production of a unit of electrical energy as compared with present wind power stations is expected.

The method of getting mechanical energy from the energy of wind according to the invention involves the use of thrust force of wind to displace the sail which is connected with a towing carriage which in turn is connected with a strand of a propelling mechanical gear. The invention of wind power generator employing sails may be applied as a ground based or on the surface of the sea or a water reservoir. The propelling wheel of the mechanical gear transfers mechanical energy to a user or to an electric power generator.

Towing carriage in the invention is a device that determines the movement trajectory of the sail. It may be a towing carriage on rails or on a rail, a raft, a yacht or a wheel cart which are connected by strands with a mechanical gear. The sail and the strand of the mechanical gear are connected to the towing carriage. In the case of using wind power generator employing sails on the surface of water, the propelling wheel and electric generator are fastened to a platform mounted to the bottom of the water reservoir. The propelling wheel transfers energy to the user or to the electric power generator.

In this invention a spinning wheel or a pair of wheels set at a distance and banded with a strand may be used as mechanical gear.

### BRIEF DESCRIPTION OF THE DRAWINGS

FIG. 1 depicts an overview of one embodiment of the invention;

FIG. 2 depicts a cross section view of the wind power generator; and

FIG. 3 depicts longitudinal cross section of wind power generator.

### DETAILED DESCRIPTION OF THE INVENTION

In the case of using the invention on the ground of the earth the equipment consists of a rotating base at which attached is a spinning wheel with a strand wound on it, of a towing carriage with a sail, guide bars on which the towing carriage with the sail is moving and an electric generator. The towing carriage with the sail is connected with the spinning wheel by a strand and the spinning wheel is connected to a mechanical energy receiver or electric power generator. One end of the strand is mounted to the spinning wheel and part of it is wound on the spinning wheel, while the other end of the strand is connected to towing carriage with the sail.

The towing carriage is in the form of a cart with a sail located at least on one guide bar at which it may roll, or it may be located on two rails or guide bars specially designed for this purpose. The rotating base having a large area ensures through its rotation that the guide bars mounted at rotational base have their trajectory compatible with the direction of the wind. At the cart—the sail mounted to the towing carriage is equipped with the mechanism designed for the angle adjustment of the sail to the direction of the wind. The working cycle of the wind power generator employing sails consists of an active part and an inactive part. In the active part of the working cycle, the sail moves under the influence of the wind and is set up orthogonally to the direction of the wind, stretches the strand that is rotating the spinning wheel and the spinning wheel transfers mechanical energy to be used. After the end of the active part of the working cycle and at the beginning of inactive part the sail rotates by one quarter of the full rotation. The turn may be carried out around a horizontal axis or a vertical axis. Such a change of the sail's position minimizes its movement resistance while returning to beginning position in the inactive part of the cycle. After returning to the beginning point the sail is again set up at the ninety degrees angle to the direction of the blowing wind.

A number of towing carriages connected in a series with one strand may be located on one guide bar or guide bars. While using two pairs of rails like in tramway rails a second pair of rails may be used for the return way and the return of the towing carriage with the sail in the inactive part of the working cycle takes place on the second pair of the rails with the sail set along the direction of the wind. A strand which was used during the active part of the cycle or an additional strand or a propeller installed on the towing carriage or an additional propeller installed on rotating plate at which mechanical gear is installed, is used for the return of the towing carriage.

A wind power generator employing sails with a towing carriage moving on the earth surface with rails is used in the following configuration. Mechanical gear and electric power generator are located on the rotational plate. Rails are located on the earth surface approximately radially, the towing carriage with the sail mounted on it moves on the rails, the towing carriage is connected to mechanical gear with a strand. There is a possibility of connecting towing carriages in a series using the same strand. Instead of one pair of rails on which one towing carriage with the sail moves, two pairs of rails are used, one pair of rails being used for the active part of the working cycle and the other pair of rails for the inactive part of the working cycle. In the case that very large sails are used, the sails are protected against tilting by wheels attached to the sails that are moving on the earth surface. The moving towing carriage with the sail is connected by strand with the mechanical gear located on the rotational base.

It is useful to apply one pair of rails or two pairs of rails connected with each other and positioned radially with reference to the rotational base, the radial rails are moving centrically on rollers over centrically positioned rails and allow setting the towing carriage with the strand in a position running along the direction of the wind.

It is possible to use a three wheel or four wheel towing carriage with the sail moving on the ground and connected to the rotational base with the mechanical gear and current generator with the towing carriage being controlled remotely.

In the case of using a wind power generator employing sails to make use of wind energy on the water surface, the rotating base is located on a platform over the water surface, the mechanical gear and current electrical generator are mounted to the base. The mechanical gear is connected with the towing carriage with at least one strand. The following may be used as towing carriages: rafts with sails, pontoons or yachts with attached sails. Application of two strands connected to two spinning wheels for steering the trajectory of the towing carriage ensures more precise movement of the towing carriage. A rotational base with two spinning wheels with separate strands allows setting the trajectory of the towing carriage running along the direction of the wind. The sail may also be in the form an inflatable mattress stiffened, for example, with pipes. During the active part of the working cycle that is when mechanical gear is propelled, the sail is set perpendicular to the water surface and the direction of the blowing wind. In the inactive part of the working cycle we have a low-loss return of the towing carriage with the sail set along the direction of the wind.

It is also possible to use the wind power generator employing sails as ground based with the utilization of two standing guide channel bars mounted on stiff base floor with a rotational base. Guide channel bars are parallel to each other. An enclosed channel of a rectangular cross section is cut out in each guide channel bar. Each enclosed channel consists of two straight segments that are parallel to each other and are of the same length, segments and are ended with cut out semi-cylinders osculated to straight segments. The surfaces of the channels cutouts in each channel guide bar play a role of a raceway forcing the assumed trajectory of the towing carriage. Let us consider these raceways.

The first raceway consists of a rectangle with the width that is equal to depth of the cutout in the guide channel bar, which transforms into an osculatory semi-cylinder of the same width (depth), next the semi-cylinder connects osculatory with a rectangle which is osculatorily connected with the semi-cylinder mentioned at the beginning. Geometric axes of the semi-cylinders are parallel, and the widths of the rectangles and semi-cylinders are identical and equal to the depth of the channels made in the guide channel bar. A raceway with bigger diameters of the semi-cylinders is called an outer raceway of the guide channel bar.

The inner raceway of the guide channel bar has semi-cylinders concentric with semi-cylinders of outer raceway and the distances between outer raceway and inner raceway at the whole length of raceways are identical.

The third raceway is a flat raceway being a layer of material connecting the two raceways mentioned earlier, it is perpendicular to the inner raceway and outer raceway and its distance from the surface of guide bar is equal to the depth of the channel made in guide channel bar. It is called the side raceway. These three raceways are used for the relocation of the rollers of the towing carriage on one side of the towing carriage. On the other side there is an identical parallel guide channel bar with three raceways. The cutout semi-cylinders in both guide channel bars have common geometrical axes, the layers of the material connecting the inner raceway and outer raceway are on the outside of guide bars when we look at them from the side of the towing carriage.

The towing carriage with the sail mounted on it moves along guide bars and besides that the towing carriage—cart is connected to the strand of the mechanical gear with two spaced wheels banded with a strand.

The towing carriage consists of: a bolt shaft 12, rollers with horizontal axes: 14, 28, 35 and 43, horizontal bolts: 34 and 42, rotationally movable arms: 33, 37, 40 and 44, rollers: 32, 36, 41, 45 with vertical axes when the rollers run along the horizontal raceways, connectors: 15 and 27 and shaft 16 supporting the sail.

In the carriage there are clamped, that is they can not rotate left bolt shaft 12 toward connector 15 of the towing carriage, and bolt shaft 12 toward the right connector 27, bolt 34 toward the left connector 15, bolt toward the right connector 27 of the towing carriage, shaft 16 supporting the sail toward the left connector 15, shaft 16 toward the right connector 27.

Geometric axes of bolt shaft 12 and bolts 34 i 42 are mutually parallel. Two front rollers or two rear rollers of towing carriage with horizontal geometrical axes may be mounted to bolt shaft 12 mating with the strand of the mechanical gear. In that description, front rollers 14 and 28 with horizontal axes are mounted on bolt shaft 12. Rear rollers 35 and 43 with horizontal axes are mounted to bolts 34 and 42. Arm 33 is mounted rotatably to bolt 34 and arm 44 is mounted rotatably to bolt 42. Bolt shaft 12 is connected: with the front side roller 36 in the left guide channel bar through the arm 37, with the front side roller 41 in the right guide channel bar through the arm 40, with the side rear roller 32 in the left guide channel bar through the left connector 15, next bolt 34 and the arm 33; with rear side roller 45 in right guide channel bar through the right connector 27, next bolt 42 and the arm 44 of the rear right roller. When the towing carriage is located at horizontal part of guide bars, rollers 14, 28, 35 and 43 block the rotation of the towing carriage around horizontal axes, including around horizontal geometrical axes of the front rollers or the rear rollers. Rotations around these axes are possible within the range of foreseen clearances and tolerances. Side rollers limit the possibilities of rotation around the axis perpendicular to surface created through parallel geometrical axes of front rollers and rear rollers while they are moving along inner or outer raceways.

Depending on total load resulting from sail weight and forces coming from the pressure of the air onto the sail, with the strong wind from the left to the right side one may expect that front rollers of towing carriage will be rolling on inner raceway and rear roller will be rolling on the outer raceway as shown on the attached example of execution when a flat part of the raceway is used.

The sail consists of a left connector 17, the rod 18 for tightening the sail from the left side, connector of rods 21 tightening the sail, rod 25 for tightening sail from the right side, right connector of sail 26. Sail cloth is hung between left side rod 18, connector of rods 21, right side rod 25. The simpler and more effective solution in terms of force is to use a plate attached to the shaft supporting the sail 16 through clamps mounted rotationally on the shaft. Application of a metal or plastic plate guarantees better use of the change of the momentum of air particles hitting the plate.

One of two shafts connecting front rollers or rear rollers is the bolt shaft of towing carriage and is connected with the strand of the mechanical gear. A section of that bolt shaft may work as a bolt of any kind of a pitch chain such as: bushing chain or block-centre chain. A section of that shaft goes through a hole made in a union piece of pitch chain, the hole being created from two semicircles connected along short distances.

In the case of using a belt transmission, the ends of belt pulleys are connected by a hinge connector, so that the bolt shaft of the towing carriage works as a hinge connector. The surfaces of the hinges are profiled so when they are touching the pulley of the transmission belt they are adjacent to the transmission belt because they have radii equal to radii of the transmission belt.

Another kind of mechanical gear that may be used is mechanical gear with V-belts. The V-belt contains a cutout with two semicircles connected by short straight segments with the axis of the cutout normal to outer surfaces of the belt. In the cutout a metal or plastic connector is inserted to which cord cloth such as threads or polyamide or metal ribbons are vulcanized.

The whole cycle of the towing carriage movement consists of an active part and an inactive part. In the active part wind pressure moves the sail in the direction of the wind. In the inactive part—that is when the sail is returning to the beginning position, the sail is tilted to reduce resistance against air. Sails are made of cloth (canvas), plastic or metal plate.

In the active part of the cycle the bolt shaft of the towing carriage moves the strands that are located on wheels or pulleys. One wheel or both wheels of the mechanical gear may be used for the further transfer of mechanical energy for direct use or for changing into electrical energy in current generators.

The sail is connected with the towing carriage or movable cart that is moving along guide bar and is set approximately with its surface perpendicularly to the direction of wind. The guide bars ensure that points of geometric axes of the rollers of the towing carriages with horizontal and parallel axes are moving along closed trajectories consisting of two equal segments of straight line terminated on their ends with two semicircles that are tangent at the place of connection and are behind straight line segments. The trajectory of geometric axes of the rollers of the towing carriage are selected in such a manner that they are close to trajectory points of a strand in the applied mechanical gear.

### NAME OF PARTS

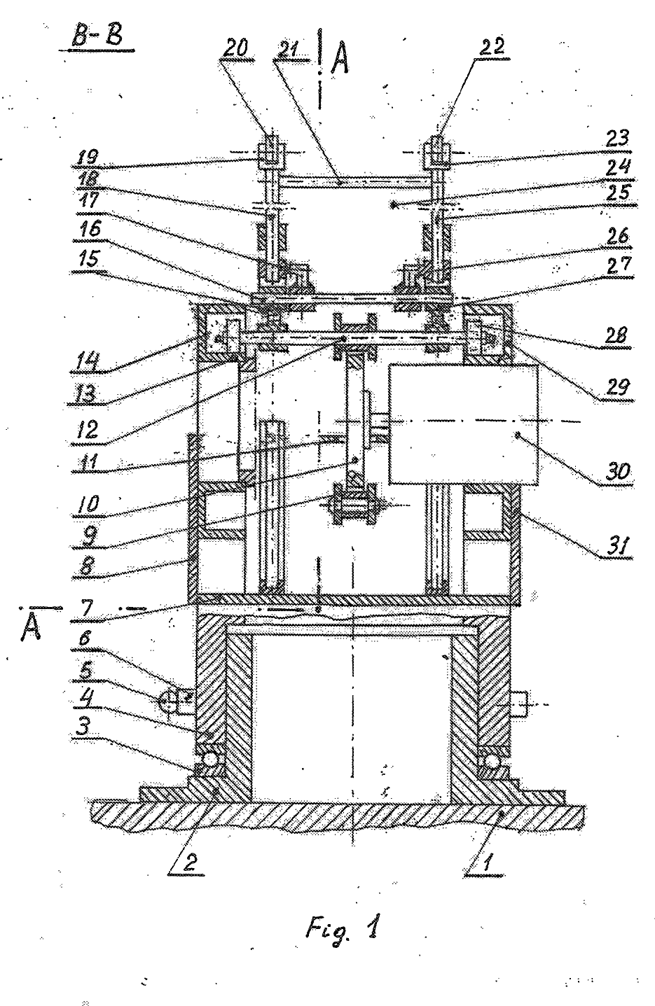

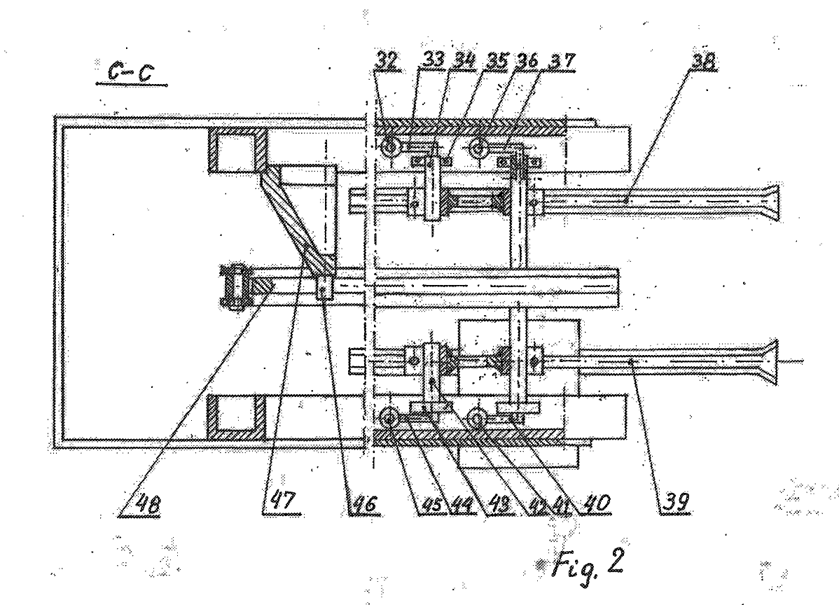

### FIG. 1

1. Concrete base

2. Positioning cylinder barrel

3. Axial bearing

4. Handling profiled cylindrical sleeve

5. Cylindrical part of reversible worm gear

6. Rolled part of reversible worm gear

7. Base floor

8. Left anti-wind shield

9. Block—centre chain

10. Toothed right wheel

11. Inside anti-wind shield

12. Bolt shaft of the towing carriage

13. Left guide channel bar

14. Left front roller of towing carriage

15. Left connector of towing carriage

16. Shaft to which sail is mounted

17. Left bottom sail connector

18. Left side rod for tightening sail

19. Holder of the left wheel for changing position of the sail

20. Left wheel of sail framing to changing frame position

21. Connector of rods tightening the sail

22. Right wheel of sail framing to changing frame position

23. Holder of the right wheel for changing position of the sail

24. Cloath sail

25. Right side rod for tightening sail.

26. Right bottom sail connector

27. Right connector of towing carriage

28. Right front roller of towing carriage

29. Right guide channel bar

30. Current generator

31. Right anti-wind shield

### FIG 2

32. Left side back roller establishing position of towing cartridge related to vertical wall of left guide channel bar

33. Arm mounting left side back wheel 32 determining position of towing carriage relative to vertical wall of left guide channel bar

34. Bolt connecting towing carriage with an arm of side back wheel that is establishing position of towing carriage to vertical wall of left guide channel bar

35. Back left roller of towing carriage

36. Front left wheel establishing position of towing carriage to vertical wall of left guide channel bar

37. Arm of front wheel 36 that is establishing position of towing carriage to vertical wall of left guide channel

38. Channel bar for left wheel of framing to changing position of sail

39. Channel bar for right wheel of framing to changing position of sail

40. Arm of the front roller 40 that is establishing position of towing carriage to vertical wall of right guide channel

41. Front right wheel establishing position of towing carriage to vertical wall of right guide channel bar

42. Bolt connecting towing carriage with an arm of side back wheel that is establishing position of towing carriage to vertical wall of lright guide channel bar

43. Right back roller of towing carriage

44. Arm mounting left side back wheel 32 determining position of towing carriage relative to vertical wall of right guide channel bar

45. Right side back wheel establishing vertical position of towing cartridge related to vertical wall of right guide channel bar

46. Shaft to mounting toothed back wheel

47. Console of the toothed back wheel mounted to left guide channel bar

48. Back toothed wheel

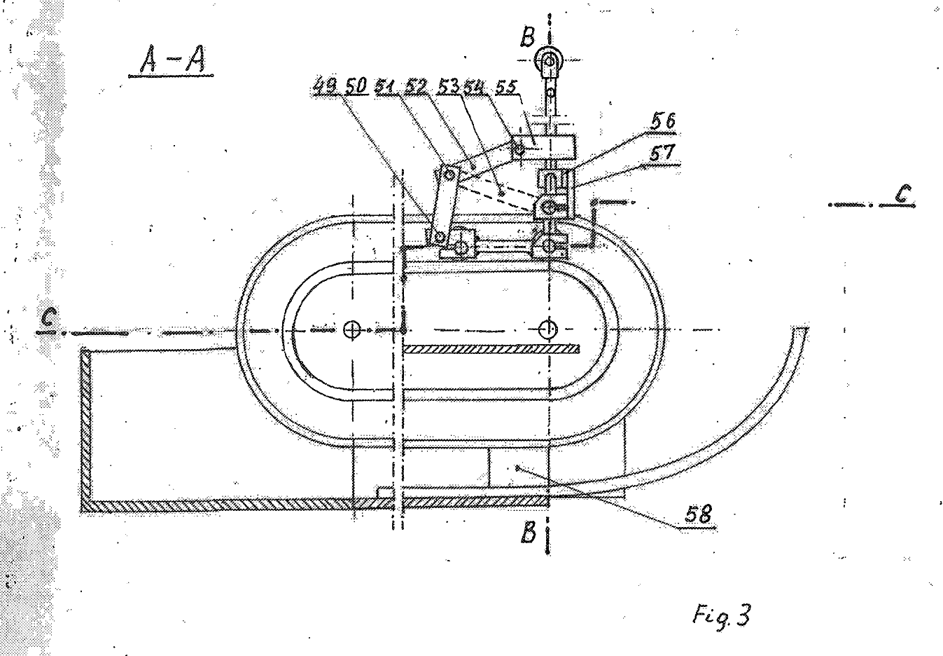

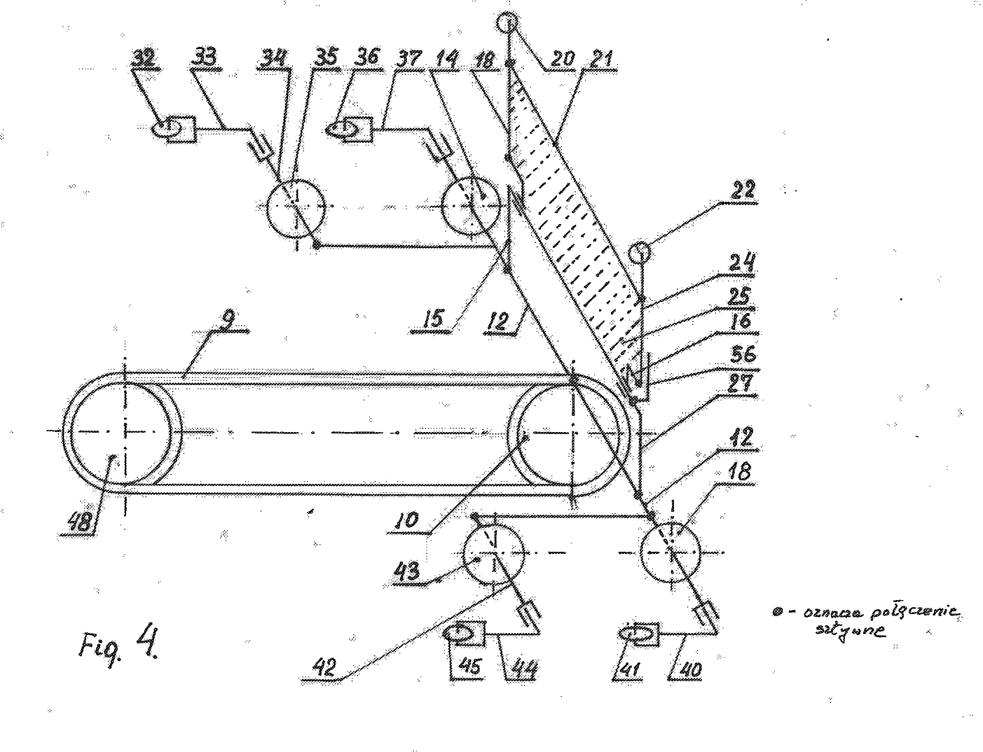

### FIG. 3.

49. Bolt connecting left arm 15 of towing carriage with bottom plate 50

50. Bottom plate tightening spring 53

51. Bolt connecting together bottom plate 50, upper plate 52 and spring 53

52. Upper plate tightening spring 53

53. Spring of the mechanism of rising sail

54. Bolt connecting upper plate 52 of the mechanism for tightening spring 52 with the clamping ring 55 tightened on rod 18

55. Connection clip on rod 18

56. Elastic bumping block

57. Plate determining vertical position of the sail at working mode

58. Column supporting left guide channel bar

A device for carrying out the method according to invention contains cylinder barrel 2 permanently attached to the base 1, installed on the cylinder barrel 2 is a true thrust bearing 3 allowing easy rotation of the structure of the wind power generator employing sails with movable sail 24 around a vertical axle. The position of the cylinder barrel 2 is selected in such a manner that its geometric axis is moving through the weight center of the structure of the wind power generator employing sails. There is a rotational base floor 7 of wind power generator employing sails mounted on the upper side to cylindrical sleeve 4, with at least one stand for each channel bar.

### EXAMPLE OF THE INVENTION IS PRESENTED IN FIGS. 1-3

The aim the drawings is to show the idea of the solution without taking into account the technical details required in technical solutions and without showing all parts on three applied views.

FIG. 1 additionally marked B-B is a vertical cross section of the wind power generator employing sails passing through the toothed wheel of mechanical chain transmission gear that is propelling current generator. In its bottom part there is a mechanism for rotating the wind power generator employing sails to set the surface of the sail normally to the direction of the wind.

Positioning cylinder barrel 2 is mounted to concrete base 1, providing vertical axis of rotation for the wind power generator employing sails. Axial bearing 3 on sleeve 2 allows easy rotation of the structure.

Base floor 7 of the power plant to which columns 58 supporting guide channel bars 13 and 29 are mounted is mounted to the cylinder 4. The supporting guide channel bars are set parallel to each other.

In each of the guide channel bars there is an enclosed cutout channel having a rectangular cross section. The cutout channel consists of two parallel segments of straight line of the same length and they are ended with cutout semi-cylinders that are connected tangent with the segments of straight channels in each of the guide channel bars. The surfaces of the channels cut out in each of the two guide channel bars play a role of raceways that force the towing carriage to move along an imposed trajectory. Guide channel bars are used for the rollers 14, 28, 35 and 43 with horizontal axes to move over them. The trajectory of the towing carriage consists of two straight segments and two semi-circles. The mechanical chain gear consisting of two toothed wheels 10 and 48 that are connected with pitch chain 9 is mounted between the guide channel bars.

In the upper part of the wind power generator employing sails there is a sail mounted in which sail cloth 24 is mounted to rod 18 that is tightening the sail on the left side, there is a connector of rods 21 and rod 25 for tightening the sail on the right side. The sail is mounted rotary to the supporting shaft 16 so as to enable rotation on the supporting shaft 16 through connectors 17 and 26. The shaft 16 is connected to a bolt shaft 12 through connectors 15 and 27 of the towing carriage. The bolt shaft 12 works as a bolt in block-centre chain 9, through which the wheels of the transmission gear are propelled.

Number 11 is for an inside wind shield separating the active area of the sail from the inactive area. Side walls of the wind power generator employing sails are covered with anti-wind shields 8 and 31 somewhat below the height of axes of toothed wheels as well with a shield from the back toothed wheel 48's side. These shields are installed there to reduce wind force on the returning leaned sail and to increase energetic efficiency of the wind power generator employing sails.

The force taken over from the wind by the sail is transferred to a current generator through sail connectors 17 and 26, supporting shaft 16, through connectors 15 and 27 of the towing carriage, bolt shaft 12 of the towing carriage, block-centre chain 9 and toothed wheel 10 connected with the current generator 30.

FIG. 2 additionally marked C-C it is a layer cross section of the wind power generator employing sails with the moving sail and it shows towing carriage in cross section and top view of the rest of the wind power generator employing sails.

Based on FIG. 3 we can see that the towing carriage is in the position after which in the case of movement the towing carriage will start its movement down along the left guide channel bar 13 and down along the right guide channel bar 29. There are four rollers shown in the drawing, roller 32 is mounted on the side arm 33 of the back left side roller, roller 36 is mounted on the side arm 37 of the front left side roller, roller 45 is mounted on the back right side arm 44 and roller 42 is mounted on the front right side arm 40.

Rollers 32 and 36 have the ability of rolling over the side raceway of left guide channel bar 13, rollers 41 and 45 have the ability of rolling over the side raceway of right guide channel bar 29. When small clearances are selected between rollers 32 and 36 and side raceway guide bar 13 as well as when small clearances are selected between rolls 41 and 45 and side raceways of guide bar 29, there will be reduced abilities of displacement for the towing carriage in the direction that is perpendicular to side raceways. To enable the change of the position of the sail, guide bars 38 and 39 of the framing have widened entrances for the rollers 20 and 22 to change the position of the sail, that is for changing its pitch.

FIG. 3 additionally marked A-A is a longitudinal cross section of wind power generator employing sails and shows the view of left guide channel bar 13 with a cutout made in it—seen from the inside of the plant. Number 47 marks a console of the shaft supporting the back toothed wheel 46. Toothed wheels 10 and 48 are mounted on such consoles. Also shown in the cross section is a tipping mechanism of mast 25. The sail-cloth on the mast is mounted among others to the rod 25 tightening the sail-cloth. From the drawing marked FIG. 1 we see when the wind is blowing from the left side to the right, the sail is in the final stage of the active cycle. The wind force presses down rod 18 of the sail to bumping block 57 with its shock absorber. The bumping block is permanently mounted perpendicular to the surface connecting horizontal axes of towing carriage rollers.

Connection clip 56 is connected by clamping to the left tightening rod 18 of the sail and upper plate 52 used for stretching out the spring, is mounted to the connection clip 56 in a rotary manner on the pin 54. Further bottom plate of the mechanism used for stretching the spring 50 is connected to the upper plate used for stretching the spring 52 by using bolt 51, while the bottom plate 50 is connected to the connection clip by using bolt 34 of the towing carriage. Rod 18 stretching the sail from the left is connected in a rotary manner to the shaft 16 by applying left bottom sail connector 17. Between bolt 51 and left connection clip 58 of the shaft 16 there is a stretched spring 53.

The towing carriage starts moving down. After the sail tightening rod 18 reaches the horizontal position, wheel 55 touches channel bar of the left roller 37 of the framing for changing position of the sail 37.

As the towing carriage is moving down along the semi-cylinder there is process of decreasing of the distance between the raceway 38 and the axis of sail rotation, so raceway 37 acts with force on the sail and makes left turn of the sail (stretching out the spring) as long as it takes nearly horizontal position, when the towing carriage finds itself at the bottom part of the raceway and below toothed wheel 10.

During the further movement of the towing carriage, the towing carriage moves in the opposite direction to the blowing wind, moving with low energetic losses because of the low cross section of the sail against the blowing wind. When the towing carriage finds itself in the position in which rollers 22 and 55 get out of the guide bars 37 and 38, that is when they are below the toothed wheel 46, the mast under the influence of its own weight and the influence of the stretched out spring 53 takes the position that is normal to the surface created by geometric axes of the rollers and at that moment the sail returns to the active part of the working cycle. In the solution in question two guide bars for tilting the mast were used, i.e. the guide bar for the left roller of the framing to change the position of the sail 37 and the guide bar for the right roller of the framing to change the position of sail 38, and the sail on the right side 24 with identical structure as the rod tightening the sail on the left side 18.

1. A method of acquiring mechanical energy by using a wind power generator employing sails characterized in that a sail mounted on the towing carriage is used for the rotation of a propulsion wheel of the mechanical gear, the towing carriage is connected to a strand and the strand transfers the force originated by the sail to the propulsion wheel of the power plant, the sail has the ability of adjustment of its angle position to the direction of the wind, the total exploitation cycle of the wind power generator employing sails consists of the working part during which the sail is moving along the direction of wind with the large sail cloth set perpendicularly to the direction of wind and of the idle part during which the sail is moving in the opposite direction to the wind with the large sail cloth turned by ninety angle degrees as compared to its direction during working part of the cycle, the mechanical gear is connected to a current generator, the current generator and mechanical gear are mounted to a rotating base, rotating base turns around the horizontal axis.

2. A method according to claim 1, characterized in that the ground-based towing carriage with the sail mounted to it is moving along the trajectory imposed by at least one guide bar on which it may roll or there are two rails, or there are two guide channel bars with rectangular cutouts, in which there are two pairs of parallel axes of the towing carriage and there are two rollers attached to each axis on both sides out of which rollers one has a horizontal axis and the other has a vertical axis.

3. A method according to claim 1, characterized in that the role of towing carriage is performed by any objects floating on the water like a raft, a yacht, a pontoon having a sail and connected with mechanical gear by one strand; while a rotating base with a plate mounted to it turns following the changes in the direction of the wind together with the generator, so the surface of the large surface of the sail is set perpendicularly to the direction of wind.

4. A device of wind power generator employing sails characterized in that in the case of using the wind power generator employing sails on the surface of water, the propulsion wheel of the mechanical gear and current generator are mounted to the platform attached to the bottom of water reservoir, propulsion wheel transfers energy to the user or to the current generator.

5. A device of wind power generator employing sails characterized in that in the case of using the wind power generator employing sails on the surface of the earth, spinning wheels with strands, or mechanical gears consisting of two wheels displaced and belted by strand, are used as mechanical gears for this invention.

6. A device according to claim 5 is characterized in that the towing carriage with a sail mounted to it is connected by strand with a spinning wheel, simultaneously the spinning wheel is connected to a receiver of mechanical energy or to a current generator, one end of the strand is attached to the spinning wheel, further part of the strand is reeled over the spinning wheel and the second end of the strand is attached to the towing carriage.

7. A device according to claim 5 is characterized in that the ground-based towing carriage with the sail mounted to it is moving along the trajectory imposed by at least one guide bar on which it may roll or there are two rails, or there are two guide channel bars with rectangular cutouts, in which there are two pairs of parallel axes of the towing carriage and there are two rollers attached to each axis on both sides out of which rollers one has a horizontal axis and the other has a vertical axis.

8. A device according to claim 4 is characterized in that the sail has the capability of rotation around vertical axis and is mounted further from the point of mounting of the towing carriage to propulsion strand, all this enabling the position of the sail mounted on the towing carriage to be set.

9. A device according to claim 8 is characterized in that two additional strands fixed to two additional spinning wheels attached to a rotary base are used for setting the angle between of the main surface of the sail in relation to the direction of the wind.

10. A device according to claim 7 is characterized in that a mechanical gear consisting of two displaced wheels and belted by a strand is mounted on a rotating plate and channels are made in two guide channel bars; the guide channel bars are set up parallel to each other, in each of guide channel bars there is a channel in the form of an enclosed cutout with a rectangular cross section, the cutout channel consists of two straight segments that are parallel and have the same length, that are ended at the sides with semi-cylinders that are connected in an osculatory manner with straight parts of the channels, the surfaces of channels cut out in each of the two guide channel bars work as raceways imposing movement on the towing carriage along an established trajectory, the first raceway consists of a rectangle with the width that equals the depth of the cutout in the guide channel bar, which transforms in an osculatory manner into a semi-cylinder having the same width, next this part of the semi-cylinder is connected in an osculatory manner with a rectangle which in turn is connected in an osculatory manner with the second semi-cylinder and that second semi-cylinder is connected in an osculatory manner with the rectangle mentioned at the beginning; geometric axes of semi-cylinders are parallel and widths of the rectangles and semi-cylinder cutouts are identical and equal to the depth of the channels made in the guide channel bar; the raceway with the bigger diameters of the semi-cylinders is called outside raceway of the guide channel bar, the internal raceway of the guide channel bar has semi-cylinder cutouts concentric with the outside raceway and distances between outside and internal raceways along the whole length of the channel are identical for the both guide channel bars and it is called internal raceway, the third raceway is a flat raceway being a layer of material of the channel bar connecting the two raceways mentioned earlier, it is perpendicular to the internal raceway and outside raceway and its distance from the surface of guide bar is equal to the depth of the channel made in the guide bar and is called a side raceway, these three raceways are used for movement of the rollers of the towing carriage over them on one side of the towing carriage, on the other side of the towing carriage there is parallel identical guide bar with three raceways; the semi-cylinders cut out in both guide bars have common geometrical axes and additionally the layers of the material connecting the internal raceway and outside raceway are situated on outside sides of the guide channel bars while looking from the position of towing carriage, towing carriage is moving along guide channel bars with the sail attached to it and besides that the towing carriage is connected with a strand of the mechanical gear with two separated wheels, that is one wheel is the propelling wheel co-operating with the propelling strand, the strand is connected to the towing carriage and the towing carriage is connected to the sail, the trajectories of the axes of the rollers and the trajectories of strand points are identical, one of two shafts connecting front or back rollers of the towing carriage is a bolt shaft of the towing carriage and is connected with the strand of the mechanical gear, one segment of the bolt shaft may work also as a bolt of the pitch chain or roller chain or block-centre chain, also a segment of this shaft constitutes a bolt going through the hole made in the chain connector of the block-centre chain, the hole consisting of two semicircles connected by short segments.

11. A device of wind power generator employing sails according to claim 10 characterized in that in case of using belt transmission, the ends of the transmission wheel are connected with a hinged connector, while the bolt shaft of the towing carriage works as the hinge pin, the surfaces of the hinges are profiled so as to be in intimate contact with transmission wheels while their touching the shaft of the belt gear, that is they should constitute parts of cylinders with the radiuses equal to radiuses of belt transmission wheels.

12. A method according to claim 10, mechanical gear with the V-belt is used in the mechanical gear with two separated wheels and the V-belt has a cutout consisting of two semicircles connected with each other with short segments with the axe of symmetry of that cutout perpendicular to the external surface of the belt; in that cutout there is metal or plastic connector to which cord fabric in the form of threads or ribbons or polyamide or metal threads is vulcanized and the bolt shaft of the towing carriage goes through this connector.

13. A device of wind power generator employing sails according to claim 10 characterized in the solution using a rotating plate to which a spinning wheel is connected with a propelling strand, the strand id connected to towing carriage, and the sail is mounted to the towing carriage, the towing carriage is moving over rails, where two pairs of rails are used that are nearly parallel, one pair used for active part of the cycle and the other used for inactive part of the cycle.

14. A device of wind power generator employing sails according to claim 13 characterized in that the rotary plate is used only for installing a mechanical gear on it with a strand and current generator is connected to the gear, towing carriages are equipped with sails and connected with the propelling wheel of the mechanical gear by strands and are moving on separated rails radially where rails are used or moving radially along a road surface constituting a large circle with the rotary plate and the centre of the circle is the same as the centre of the rotary plate and the rotary plate follows the direction of the wind so that the direction of the propelling strand is approximately compatible with the direction of the wind.

15. A device of wind power generator employing sails according to claim 14 characterized in that there is one pair of rails or there are two pairs of rails set radially to the axis of the rotary plate, where the rails are approximately parallel to each other and the rails are capable of rotation around the horizontal axis of the rotary table on wheels radially and the axis of the circle is centrical with the axis of the rotary base.

16. A device of wind power generator employing sails according to claim 7 characterized in that a rotary plate is used for installing a mechanical gear on it with a strand and current generator is connected to the mechanical gear, there are two channel bars with cut out channels in which the towing carriage is moving—the towing carriage is equipped with sail and is connected to the propelling wheel of mechanical gear by a strand, the mechanical gear consists of two wheels banded with chain strand; the towing carriage consists of: a bolt shaft 12, rollers with horizontal axes: 14, 28, 35 and 43, horizontal bolts: 34 and 42, rotationally movable arms: 33, 37, 40 and 44, rollers: 32, 36, 41, 45 with vertical axes when the rollers run along the horizontal raceways, connectors: 15 and 27, shaft 16 supporting the sail, left connector 15 of the towing carriage and right connector 27 of the towing carriage are clamped on bolt shaft 12, bolt 34 is clamped by the left connector 15 of towing carriage, bolt 42 is clamped by the right connector 27 of the towing carriage, shaft 16 supporting the sail is clamped by the left connector 15, shaft 16 is clamped by the right connector 27, geometric axes of bolt shaft 12 and bolts 34 i 42 are mutually parallel, two front rollers or two rear rollers of towing carriage with horizontal geometrical axes may be mounted to bolt shaft 12 mating with the strand of the mechanical gear, in that description, front rollers 14 and 28 with horizontal axes are mounted on bolt shaft 12, rear rollers 35 and 43 with horizontal axes are mounted to bolts 34 and 42, arm 33 is mounted rotatably to bolt 34 and arm 44 is mounted rotatably to bolt 42, bolt shaft 12 is connected: with the front side roller 36 in the left guide channel bar through the arm 37, with the front side roller 41 in the right guide channel bar through the arm 40, with the side rear roller 32 in the left guide channel bar through the left connector 15, next bolt 34 and the arm 33; with rear side roller 45 in right guide channel bar through the right connector 27, next bolt 42 and the arm 44 of the rear right roller, when the towing carriage is located at horizontal part of guide bars, rollers 14, 28, 35 and 43 block the rotation of the towing carriage around horizontal axes, including around horizontal geometrical axes of the front rollers or the rear rollers, rotations around these axes are possible within the range of foreseen clearances and tolerances, side rollers limit the possibilities of rotation around the axis perpendicular to surface created through parallel geometrical axes of front rollers and rear rollers while they are moving along inner or outer raceways; depending on total load resulting from sail weight and forces coming from the pressure of the air onto the sail, with the strong wind from the left to the right side one may expect that front rollers of towing carriage will be rolling on inner raceway and rear roller will be rolling on the outer raceway as shown on the attached example of execution when a flat part of the raceway is used; the sail consists of a left connector 17, the rod 18 for tightening the sail from the left side, connector of rods 21 tightening the sail, rod 25 for tightening sail from the right side, right connector of sail 26; sail cloth is hung between left side rod 18, connector of rods 21, right side rod 25; the simpler and more effective solution in terms of force is to use a plate attached to the shaft supporting the sail 16 through clamps mounted rotationally on the shaft; application of a metal or plastic plate guarantees better use of the change of the momentum of air particles hitting the plate; one of two shafts connecting front rollers or rear rollers is the bolt shaft of towing carriage and is connected with the strand of the mechanical gear; a section of that bolt shaft may work as a bolt of any kind of a pitch chain such as: bushing chain or block-centre chain; a section of that shaft goes through a hole made in a union piece of pitch chain, the hole being created from two semicircles connected along short distances.
